(19) United States
(12) Patent Application Publication
(10) Pub. No.: US 2026/0029818 A1
(43) Pub. Date: Jan. 29, 2026

(54) SIGNAL SKEW COMPENSATION APPARATUS AND METHOD

(71) Applicant: HUNAN GREAT-LEO MICROELECTRONICS CO., LTD., Hunan (CN)

(72) Inventors: Yunjie LIU, Hunan (CN); Hu CHEN, Hunan (CN); Binshan WU, Hunan (CN); Huanrong YANG, Hunan (CN)

(73) Assignee: HUNAN GREAT-LEO MICROELECTRONICS CO., LTD., Hunan (CN)

(21) Appl. No.: 18/997,185

(22) PCT Filed: Jul. 19, 2023
(86) PCT No.: PCT/CN2023/108160

§ 371 Date: Jan. 21, 2025

(30) Foreign Application Priority Data
Jul. 21, 2022 (CN) 202210859638.5

(51) Int. Cl. G06F 1/10

(52) U.S. Cl. CPC G06F 1/10

(57) ABSTRACT

The invention discloses a signal skew compensation apparatus and method. The signal skew compensation apparatus comprises: a clock detection module (1) for detecting a frequency output of an input clock signal; a DELAY module (2) for receiving a data signal and introducing a delay, a delay amount being controlled and delayed data being output based on the frequency detected by the clock detection module (1) and a DELAY value output by a data parsing control module (3); and the data parsing control module (3) for receiving the delayed data and parsing a PING message therein, and adjusting the output DELAY value based on a parsing result. The invention has the advantages of simple implementation, low cost, dynamically adjustable signal skew compensation amount, and high flexibility, real-time performance and efficiency.

### CROSS-REFERENCE TO RELATED APPLICATIONS

This application is based on the Chinese patent application filed on Jul. 21, 2022, under application No. 202210859638.5, titled “SIGNAL SKEW COMPENSATION APPARATUS AND METHOD”, and claims its priority. The entire content of the Chinese patent application is hereby incorporated into this application as a part of this application.

### TECHNICAL FIELD

The invention relates to the technical field of data communication, in particular to a signal skew compensation apparatus and method.

### DESCRIPTION OF RELATED ART

In data communication, the quality of PCB board traces is the most significant factor affecting data communication quality. To minimize the impact of external factors on data transmission quality, it is often necessary to embed a skew compensation mechanism within a chip to enhance the robustness of data communication.

In the prior art, skew compensation is usually achieved through a combination of hardware circuits and software calculations to eliminate clock and data signal skew caused by board trace quality issues such as line length mismatches. The aforementioned skew compensation hardware circuit typically includes a set of delay units (line delay units), which, in conjunction with software, perform calculations to determine the degree of signal skew and compensate for line delays. However, this approach has the following issues:
(1) the need for a CPU to calculate the degree of signal skew consumes CPU computing resources; and
(2) the delay of the line delay units is limited, allowing only for fine-tuning, meaning that the amount of signal skew compensation is typically fixed and non-adjustable, which may result in failure to correctly acquire data even when the maximum delay is applied in practical applications.

In the prior art, the commonly used signal skew compensation amount in chip design is typically 32 TAP, and the accuracy is fixed after the chip is fabricated through tape-out. For example, at a frequency of 300 MHz and an accuracy of 0.1 ns, the adjustable signal period after tape-out is only 3.2 ns. However, when the input frequency decreases to 100 MHz, the signal period becomes 10 ns, which means there is a 6.8 ns region that cannot be covered. When the signal quality is poor, such as when the stable region of the signal is only 30%, there is a high likelihood that normal data will not be captured.

### SUMMARY

To address the technical problems present in the prior art, the invention provides a signal skew compensation apparatus and method characterized by simple implementation, low cost, dynamically adjustable signal skew compensation amount, and high flexibility, real-time performance and efficiency.

To solve the above technical problems, the invention provides the following technical solution:

A signal skew compensation apparatus, comprising:
a clock detection module for detecting a frequency output of an input clock signal;
a DELAY module for receiving a data signal and introducing a delay, a delay amount being controlled and delayed data being output based on the frequency detected by the clock detection module and a DELAY value output by a data parsing control module; and
the data parsing control module, configured to receive the delayed data and parse a PING message therein, and adjust the output DELAY value based on a parsing result.

Further, the DELAY module comprises a DELAY control unit and a DELAY unit which are interconnected, the DELAY control unit calculates a control value based on the frequency detected by the clock detection module and outputs the same to the DELAY unit, and the DELAY unit generates a corresponding delay of a specific duration based on the control value and the DELAY value.

Further, the DELAY unit comprises a line delay subunit and a selection subunit, the line delay subunit comprises a plurality of sequentially connected delay circuits, an output terminal of each of the delay circuits is connected to the selection subunit, and the selection subunit selects a target delay circuit for access based on the control value and the DELAY value, allowing the data signal to be output through the target delay circuit.

Further, the control value is a jump value between adjacent delay circuits in desired delay circuits, and the selection subunit determines all the desired delay circuits from the line delay subunit based on the jump value, and selects the target delay circuit from the identified delay circuits based on the DELAY value.

Further, the jump value is calculated as 300/Fre_det. Fre_det being the detected frequency value.

Further, the selection subunit selects a delay circuit corresponding to the DELAY value from all the identified desired delay circuits to serve as the target delay circuit.

Further, the selection subunit is a multiplexer, and a control terminal of the multiplexer receives the control value and the DELAY value.

Further, the data parsing control module comprises a parsing circuit unit and a storage unit, and the parsing circuit unit is configured to parse the PING message in the delayed data, continuously adjust the DELAY value, and store a minimum DELAY value allowing successful parsing and a maximum DELAY value at which parsing begins to fail in the storage unit.

Further, the data parsing control module also comprises an optimum sampling point calculation unit, which calculates the DELAY value corresponding to an optimum sampling point based on the minimum DELAY value and maximum DELAY value stored in the storage unit.

A signal skew compensation method, comprising:
detecting a frequency of an input clock signal;
receiving a data signal and introducing a delay, a delay amount being controlled and delayed data being output based on the detected frequency and a DELAY value; and
receiving the delayed data and parsing a PING message therein, and adjusting the output DELAY value based on a parsing result; wherein
receiving the delayed data and parsing a PING message therein further comprises capturing the DELAY value corresponding to an optimum sampling point based on the parsing results for each DELAY value.

Further, the delay amount based on the detected frequency and a DELAY value comprises:
calculating a control value based on the detected frequency; and
selecting a target delay circuit for access from a plurality of sequentially connected delay circuits based on the control value and the DELAY value, allowing the data signal to be output through the target delay circuit, resulting in a corresponding delay of a specific duration.

Further, the control value is a jump value between adjacent delay circuits in desired delay circuits, all the desired delay circuits are identified from the plurality of sequentially connected delay circuits based on the jump value, and the target delay circuit is selected from the identified delay circuits based on the DELAY value.

Further, the jump value is calculated as 300/Fre_det, Fre_det being the detected frequency value, and a delay circuit corresponding to the DELAY value is selected from all the identified desired delay circuits to serve as the target delay circuit.

Further, receiving the delayed data and parsing a PING message further comprises capturing the DELAY value corresponding to an optimum sampling point based on the parsing results for each DELAY value, specifically comprising:
acquiring a minimum DELAY value allowing successful parsing and a maximum DELAY value at which parsing begins to fail; and
calculating the DELAY value corresponding to the optimum sampling point based on the minimum DELAY value and the maximum DELAY value.

Further, if the data parsing control module fails to parse the PING message after power-up, capturing the DELAY value corresponding to an optimum sampling point based on the parsing results for each DELAY value comprises:
increasing the current DELAY value based on a preset step size and evaluating the possibility of successfully parsing the PING message by the data parsing control module at the current DELAY value, if parsing fails, continuing to increase the DELAY value until initial successful parsing occurs, and obtaining the minimum DELAY value based on the DELAY value corresponding to the initial successful parsing;
continuing to increase the current DELAY value based on the preset step size and evaluating the possibility of successfully parsing the PING message by the data parsing control module at the current DELAY value, if parsing succeeds, continuing to increase the DELAY value until a parsing error occurs, and obtaining the maximum DELAY value based on the DELAY value corresponding to the parsing error; and
calculating the DELAY value corresponding to the optimum sampling point based on the minimum DELAY value and the maximum DELAY value.

Further, if the data parsing control module is able to parse the PING message after power-up, capturing the DELAY value corresponding to an optimum sampling point based on the parsing results for each DELAY value comprises:
obtaining a configuration value of the minimum DELAY value;
increasing the current DELAY value based on the preset step size and evaluating the possibility of successfully parsing the PING message at the current DELAY value, if parsing succeeds, decreasing the current DELAY value based on the preset step size until an initial parsing error occurs, and obtaining the maximum DELAY value based on the DELAY value corresponding to the initial parsing error; and
calculating the DELAY value corresponding to the optimum sampling point based on the maximum DELAY value and the configuration value of the minimum DELAY value.

Further, the DELAY value corresponding to the optimum sampling point is obtained using the formula (A+B)/2, A being the minimum DELAY value and B being the maximum DELAY value.

A chip, comprising a chip body, wherein the signal skew compensation apparatus or a module for executing the method is arranged inside the chip body.

A computer-readable storage medium storing a computer program, wherein the computer program, when executed, realizes the method.

A data communication method, comprising:
resetting a receiving device after power-up and performing initialization settings, the receiving device being equipped with the signal skew compensation apparatus or a module for executing the method; and
controlling synchronization between the receiving device and a transmitting device, the synchronization being accomplished by capturing the DELAY value corresponding to an optimum sampling point is captured by controlling the method based on claim 14-17, and setting the DELAY value based on the DELAY value corresponding to the optimum sampling point; and after the synchronization is completed, beginning to receive, by the receiving device, a
data stream sent by a transmitting end.

Compared with the prior art, the invention has the following advantages.

1. The invention detects the frequency of an input clock signal and controls the delay of an input data signal based on clock frequency and a DELAY value. Additionally, the DELAY value is adjusted based on a parsing result of a PING message. This allows for signal adjustment through data parsing, enabling real-time and highly efficient signal skew compensation. The delay amount of the data signal is dynamically determined based on the clock frequency and the DELAY value, enabling dynamically adjustable signal skew compensation. This ensures that data can be accurately captured after compensation.

2. The invention, through skew compensation of data signals, not only mitigates the effects of line length mismatches and electronic components, but also enables more accurate and robust data acquisition by a clock, while also freeing up substantial CPU resources.

3. The invention utilizes multiple line delay units to achieve adjustable line delay, covering a large portion of the signal range. This ensures that even in environments with poor signal quality, reliable and accurate data acquisition can still be achieved. Further, normal operation can be maintained under extreme conditions, such as high and low temperatures.

### BRIEF DESCRIPTION OF THE DRAWINGS

FIG. 1 is a structural diagram of a signal skew compensation apparatus based on an embodiment.

FIG. 2 is a schematic diagram of a specific structure of a clock detection module based on an embodiment.

FIG. 3 is a structural diagram of a DELAY module based on an embodiment.

FIG. 4 is a schematic diagram of a specific structure of a DELAY unit based on an embodiment.

FIG. 5 is a flowchart of signal skew compensation based on an embodiment.

FIG. 6 is a flowchart illustrating the process of capturing an optimum sampling point in a first scenario of an embodiment, where a PING message cannot be parsed upon power-up.

FIG. 7 is a flowchart illustrating the process of capturing an optimum sampling point in a second scenario of an embodiment, where a PING message can be parsed upon power-up.

FIG. 8 is a schematic diagram of the workflow of a signal skew compensation apparatus during data communication based on an embodiment.

FIG. 9 illustrates the results before and after signal skew compensation obtained in a specific application embodiment.

Description of reference numerals: 1. clock detection module; 2. DELAY module; 201. DELAY control unit; 202. DELAY unit; 221. line delay subunit; 222. selection subunit; 3. data parsing control module: 301. parsing circuit unit: 302. storage unit.

### DESCRIPTION OF THE EMBODIMENTS

The invention will be further described with reference to the attached drawings in the specification and specific preferred embodiments, but this does not limit the scope of protection of the invention.

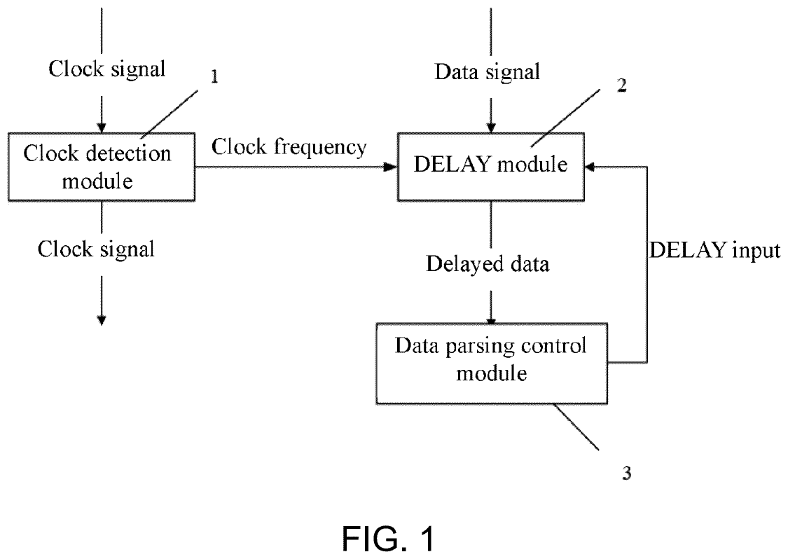

As shown in FIG. 1, a signal skew compensation apparatus based on an embodiment comprises:
a clock detection module 1 for detecting a frequency output of an input clock signal, the input clock signal being a clock signal of a received data signal;
a DELAY module 2 for receiving a data signal and introducing a delay, a delay amount
being controlled and delayed data being output based on the frequency detected by the clock detection module 1 and a DELAY value output by a data parsing control module 3; and
the data parsing control module 3 for receiving the delayed data and parsing a PING message therein, and adjusting the output DELAY value based on a parsing result.

Based on the embodiment, the frequency of the input clock signal is detected through the clock detection module 1, and the delay of the input data signal is controlled by the DELAY module 2 based on the clock frequency and the DELAY value. Additionally, the DELAY value is adjusted by the data parsing control module 3 based on the parsing result of the PING message. This allows for signal adjustment through data parsing, enabling real-time and highly efficient signal skew compensation. The delay amount of the data signal is dynamically determined based on the clock frequency and the DELAY value, enabling dynamically adjustable signal skew compensation. This ensures that data can be accurately captured after compensation, and the entire compensation process does not occupy CPU resources.

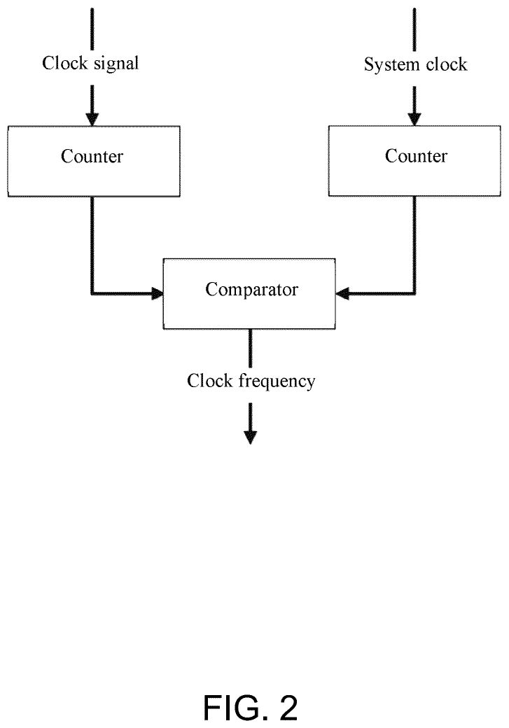

In a specific application embodiment, the clock detection module 1 can determine the frequency of a clock to be detected by counting the number of reference clocks (system clocks) within a certain number of clock cycles to be detected. As shown in FIG. 2, the clock detection module 1 may be implemented using two counters and a comparator. The two counters count the clock to be detected and the system clock respectively, and the clock frequency output is obtained after comparison by the comparator. The clock frequency can be calculated using the following formula:

$$\frac{Num\_sys}{Fre\_sys} = \frac{Num\_det}{Fre\_det} \text{=>} Fre\_det = \frac{Num\_det * Fre\_sys}{Num\_sys} \qquad ( 1 )$$

where Fre_sys is the system clock, Num_sys is the count value of the counter for the system clock, Fre_det is the clock frequency of the clock to be detected, and Num_det is the count value of the counter for the clock to be detected.

For example, if the system clock Fre_sys is 50 M, the counter value Num_sys is 1000, and the counter value Num_det for the clock signal to be detected Fre_det is 100, then the clock frequency of the clock signal to be detected is 5 M.

It can be understood that the clock detection module 1 may also be implemented using other structures for clock frequency detection, which can be selected based on actual requirements.

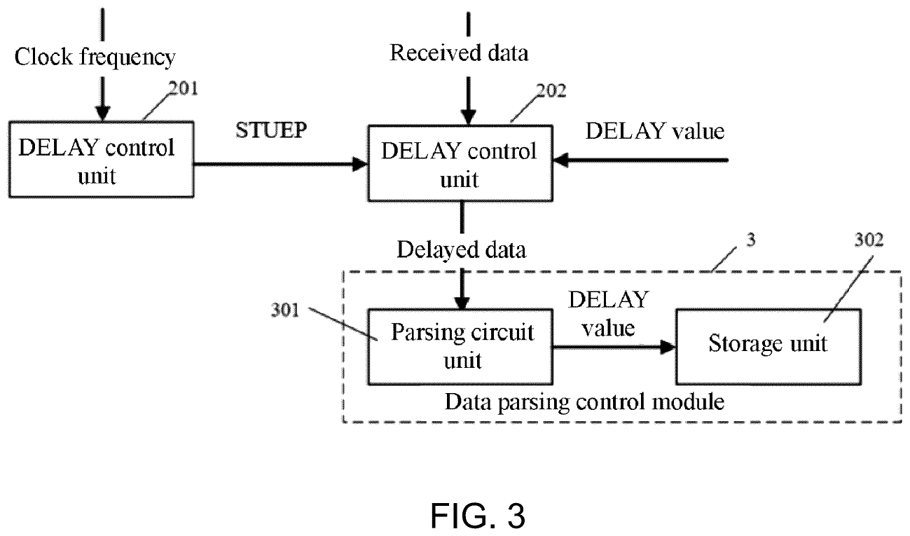

The DELAY module 2, as the core of the entire skew compensation circuit, determines the delay amount based on the input clock frequency detected by the clock detection module 1 and the DELAY value output by the data parsing control module 3, enabling dynamic adjustment of the delay amount. Referring to FIG. 3, in this embodiment, the DELAY module 2 specifically comprises a DELAY control unit 201 and a DELAY unit 202 which are interconnected, the DELAY control unit 201 calculates a control value based on the frequency detected by the clock detection module 1 and outputs the same to the DELAY unit 202, and the DELAY unit 202 generates a corresponding delay of a specific duration based on the control value and the DELAY value. The DELAY control unit 201 first calculates a control value based on the frequency detected by the clock detection module 1, and outputs the control value to a control terminal of the DELAY unit 202. The DELAY value output by the data parsing control module 3 is input to another control terminal of the DELAY unit 202. The DELAY unit 202 determines the final delay amount based on the control value and the DELAY value.

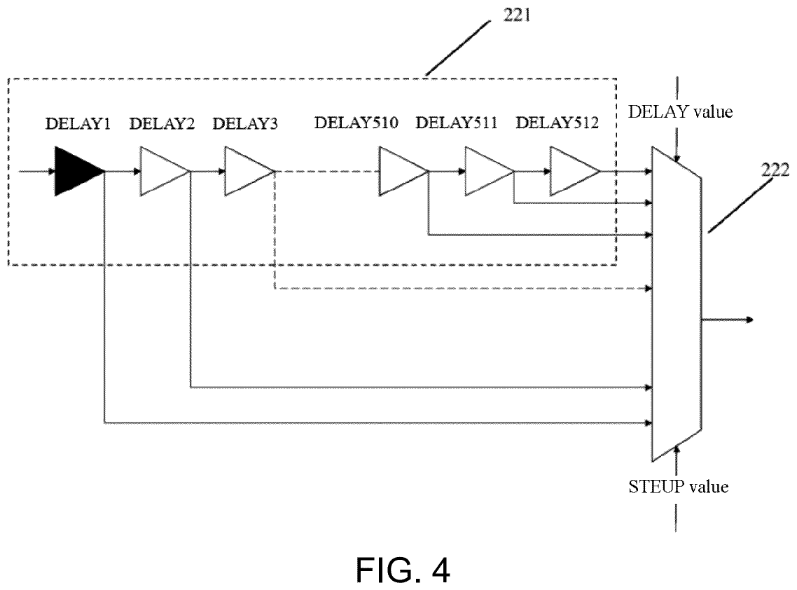

As shown in FIG. 4, in this embodiment, the DELAY unit 202 may be implemented using a line delay subunit 221 and a selection subunit 222. The line delay subunit 221 comprises a plurality of sequentially connected delay circuits, and an output terminal of each of the delay circuits is connected to the selection subunit 222. The delay circuit specifically consists of delayers, namely DELAY1 through DELAY512, connected in sequence to constitute the line delay subunit 221. The selection subunit 222 selects a target delay circuit for access based on the control value and the DELAY value, allowing the data signal to be output through the target delay circuit, thus achieving the desired delay amount.

It can be understood that in other embodiments, the DELAY unit 202 may also adopt different delay structures, such as delay circuits formed by RC structures, operational amplifier circuits, or thyristor circuits. Additionally, adjustable delay functionality may be achieved by combining software control with microcontrollers such as single chip microcomputers or MCUs, with the specific choice depending on actual requirements.

In this embodiment, the control value specifically refers to a jump value (STEUP) between adjacent delay circuits in desired delay circuits. If the jump value is an integer, the delay circuits are selected based on the jump value, where the sequence interval between adjacent delay circuits is the jump value. If the jump value is a decimal, rounding is applied, with the previous value being floored and the next value also being floored. For example, when the jump value is 1.5, it is first rounded down (to 1), then rounded up (to 2), alternating in this manner. The selection subunit 222 determines all the desired delay circuits from the line delay subunit 221 based on the jump value, initially establishing the selection range for the delay amount. Then, based on the DELAY value, the target delay circuit is selected from the identified delay circuits to determine the final delay amount. In other words, the selection subunit 222 uses the input DELAY value and STEUP value to choose which delay circuit the signal will pass through to obtain the delayed data, thereby controlling the generation of the required delay amount. The delay circuit specifically refers to a circuit with a fixed delay time, and the delay time for each delay circuit may be configured based on actual needs.

In this embodiment, the jump value is specifically calculated based on the frequency value detected by the clock detection module 1. In a specific application embodiment, the jump value may be calculated using the following formula:

$$STEUP = \frac{300}{Fre\_det} \qquad ( 2 )$$

where Fre_det is the frequency value detected by the clock detection module 1.

For example, when the input frequency is 300 M, the data period is 3.33 ns, divided into 32 TAPs, resulting in a single precision of 0.104 ns and a line delay of 0.1 ns. At this frequency, the STEUP value is 1. Using the STEUP value, 31 delay circuits are selected from the line delay unit, resulting in the used delay circuits being DELAY1, DELAY2, DELAY3, . . . , DELAY29, DELAY30.

When the input frequency is 150 M, the data period is 6.66 ns, divided into 32 TAPs, resulting in a single precision of 0.208 ns. Since the minimum precision of the designed line delay is 0.1 ns, the STEUP value in this case is 2. Consequently, the desired delay circuits are DELAY2, DELAY4, DELAY6, . . . , DELAY60, DELAY62.

When the input frequency is 200 M, the data period is 5 ns, divided into 32 TAPs, resulting in a single precision of 0.156 ns. The STEUP value is 1.5. By first rounding down and then rounding up alternately for 1.5, the desired delay circuits are determined to be DELAY1, DELAY3, DELAY4, DELAY6, . . . , DELAY43, DELAY45, DELAY48.

It can be understood that the jump value may also be calculated using other methods based on actual needs. The control value may also be other parameter values besides the jump value based on the required selection rules.

In this embodiment, the selection subunit 222 specifically selects a delay circuit corresponding to the DELAY value from all the identified desired delay circuits to serve as the target delay circuit. For example, a delay circuit with a sequence value corresponding to the DELAY value is selected from all the identified desired delay circuits to serve as the target delay circuit. The selection subunit 222 may specifically be a multiplexer, and a control terminal of the multiplexer receives the control value and the DELAY value, and outputs the delayed data.

For instance, when the input DELAY value ranges from 0 to 31, as described earlier, if the input frequency is 300 M and the STEUP value is 1, the desired delay circuits are DELAY1, DELAY2, DELAY3, . . . , DELAY29, DELAY30. If the DELAY value is set to 3, the final selected delay circuit will be DELAY3, so the received data signal will pass through DELAY3 to produce the delayed data. When the input frequency is 150 M, as stated above, with a STEUP value of 2, the desired delay circuits are DELAY2, DELAY4, DELAY6, . . . , DELAY60, DELAY62. If the DELAY value is set to 3, the final selected delay circuit will be DELAY6, meaning the received data signal will pass through DELAY6 to produce the delayed data. When the input frequency is 200 M, as mentioned above, with a STEUP value of 1.5, the desired line delay circuits are DELAY1, DELAY3, DELAY4, DELAY6, . . . , DELAY43, DELAY45, DELAY48. If the DELAY value is set to 3, the final selected delay circuit will be DELAY4, meaning the received data signal will pass through DELAY4 to produce the delayed data.

It can be understood that the selection subunit 222 may also adopt other circuit structures aside from multiplexers. For instance, a switch structure may be utilized, where a control switch is arranged at an output terminal of each delay circuit, and by controlling the control switches at the output terminals of the various delay circuits, which delay circuit outputs the delayed signal can be determined. Additionally, it is possible to integrate software control with microcontrollers such as single-chip microcomputers and MCUs to achieve selection control. By sending control signals through the microprocessor, the selection of which delay circuit outputs the delayed signal can be controlled. The specific choices and configurations can be tailored to actual requirements.

This embodiment utilizes frequency detection to determine STEUP and multiple line delay units, achieving adjustable line delay precision. This allows for adjustable line delays that can cover 90% or even 100% of the signal range, enabling effective signal acquisition even in poor signal quality environments.

In this embodiment, the data parsing control module 3 comprises a parsing circuit unit 301 and a storage unit 302, and the parsing circuit unit 301 is configured to parse the PING message in the delayed data, continuously adjust the DELAY value, and store a minimum DELAY value allowing successful parsing and a maximum DELAY value at which parsing begins to fail in the storage unit 302. The main purpose of the PING message is to work with the signal skew compensation apparatus to achieve optimal signal sampling. The storage unit 302 may specifically be implemented using registers.

In this embodiment, the PING message specifically contains a total of 24 bits, as shown in Table 1, which includes six fields: Precursor (PRE), Start of Frame (SOF), Device Type (D_TYPE), Frame Type (F_TYPE), End of Frame (EOF), and Postcursor (POS). The values for each field are illustrated in Table 1, and the content transmitted over a single data line is the same as that transmitted over multiple data lines. When using multiple data lines, the DELAY value is adjusted while simultaneously parsing the multiple data lines, with each data line parsing the PING message. The parsing circuit continuously adjusts the DELAY value to parse the PING message, and when the parsing circuit can successfully parse the PING message, the current DELAY value is considered successful. This embodiment employs a hardware structure to determine whether parsing is successful, integrating multiple line delay units and frequency detection to assist in data parsing, thereby efficiently achieving signal skew compensation without consuming CPU resources.

TABLE 1
PING message format

| TYPE | PRE | SOF | D_TYPE | F_TYPE | EOF | POS |
|---|---|---|---|---|---|---|
| PING | 1111 | 1010 | 0000 | 0000 | 0101 | 1111 |

In this embodiment, the data parsing control module 3 also comprises an optimum sampling point calculation unit, which calculates the DELAY value corresponding to an optimum sampling point based on the minimum DELAY value and maximum DELAY value stored in the storage unit. This ensures that data is collected at the optimum sampling point, thereby guaranteeing the effectiveness of data acquisition.

In this embodiment, capturing, by the data parsing control module 3, the DELAY value corresponding to the optimum sampling point based on the parsing results for each DELAY value comprises:
acquiring a minimum DELAY value allowing successful parsing and a maximum DELAY value at which parsing begins to fail; and
calculating the DELAY value corresponding to the optimum sampling point based on the minimum DELAY value and the maximum DELAY value.

In this embodiment, when adjusting the DELAY value, the parsing circuit starts from the leftmost DELAY value that cannot correctly parse the PING message and continues until it successfully parses the PING message for the first time. The successful leftmost DELAY value (A) is stored as the desired minimum DELAY value in a DELAYA register. Then, the DELAY value is adjusted, beginning from the leftmost DELAY value that can consistently parse the PING message, and gradually adjusted until it reaches the first leftmost DELAY value (B) that fails to parse the PING message. This value represents the desired maximum DELAY value and is stored in a DELAYB register.

In a specific application embodiment, the DELAY value corresponding to the optimum sampling point is obtained using the formula (A+B)/2, A being the minimum DELAY value and B being the maximum DELAY value. It can be understood that the DELAY value corresponding to the optimum sampling point may also be adjusted based on the actual adjustments made to the DELAY value.

In a specific application embodiment, the parsing circuit may be implemented using internal logic circuits within a chip, such as by designing a data parsing circuit using the Verilog programming language.

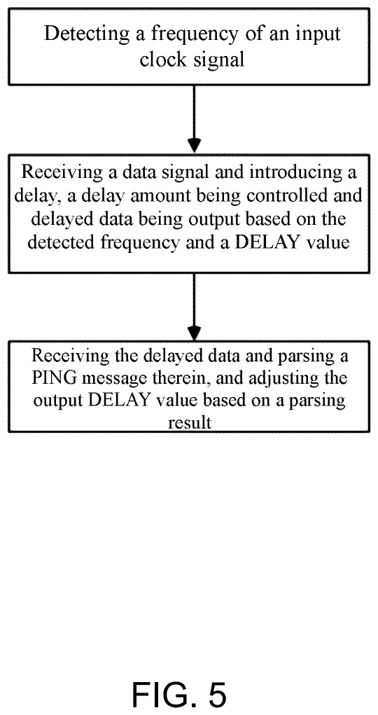

As shown in FIG. 5, a signal skew compensation method based on an embodiment comprises:
S01, detecting a frequency of an input clock signal;
S02, receiving a data signal and introducing a delay, a delay amount being controlled and delayed data being output based on the detected frequency and a DELAY value; and
S03, receiving the delayed data and parsing a PING message therein, and adjusting the output DELAY value based on a parsing result.

In a specific application embodiment, the step S01 may be implemented using the clock frequency detection module 1 as described above, the step S02 may be implemented using the DELAY module 2 as described above, and the step S03 may be implemented using the data parsing control module 3 as described above.

In this embodiment, controlling the delay amount based on the detected frequency and the DELAY value in S02 comprises:
S201, calculating a control value based on the detected frequency; and
S202, selecting a target delay circuit for access from a plurality of sequentially connected delay circuits based on the control value and the DELAY value, allowing the data signal to be output through the target delay circuit, resulting in a corresponding delay of a specific duration.

The control value is specifically a jump value between adjacent delay circuits in desired delay circuits, all the desired delay circuits are identified from the plurality of sequentially connected delay circuits based on the jump value, and the target delay circuit is selected from the identified delay circuits based on the DELAY value. The jump value is calculated as 300/Fre_det. Fre_det being the detected frequency value, and a delay circuit corresponding to the DELAY value is selected from all the identified desired delay circuits to serve as the target delay circuit.

In this embodiment, receiving the delayed data and parsing a PING message therein in S02 further comprises capturing the DELAY value corresponding to an optimum sampling point based on the parsing results for each DELAY value, specifically comprising:
S211, acquiring a minimum DELAY value allowing successful parsing and a maximum DELAY value at which parsing begins to fail; and
S212, calculating the DELAY value corresponding to the optimum sampling point based on the minimum DELAY value and the maximum DELAY value.

The signal skew compensation method in this embodiment corresponds to the signal skew compensation apparatus mentioned above, and will not be elaborated on again.

Regarding capturing the DELAY value corresponding to the optimum sampling point. this embodiment specifically covers two different scenarios.

### First Scenario: Unable to Parse the PING Message Upon Power-Up

S211, if the data parsing control module 3 fails to parse the PING message after power-up, capturing the DELAY value corresponding to an optimum sampling point based on the parsing results for each DELAY value comprises:
S212, increasing the current DELAY value based on a preset step size and evaluating the possibility of successfully parsing the PING message by the data parsing control module 3 at the current DELAY value, if parsing fails, continuing to increase the DELAY value until initial successful parsing occurs, and obtaining the minimum DELAY value based on the DELAY value corresponding to the initial successful parsing;
S213, continuing to increase the current DELAY value based on the preset step size and evaluating the possibility of successfully parsing the PING message by the data parsing control module 3 at the current DELAY value, if parsing succeeds, continuing to increase the DELAY value until a parsing error occurs, and obtaining the maximum DELAY value based on the DELAY value corresponding to the parsing error; and
S214, calculating the DELAY value corresponding to the optimum sampling point based on the minimum DELAY value and the maximum DELAY value.

In S214, the DELAY value corresponding to the optimum sampling point is obtained using the formula (A+B)/2, A being the minimum DELAY value and B being the maximum DELAY value.

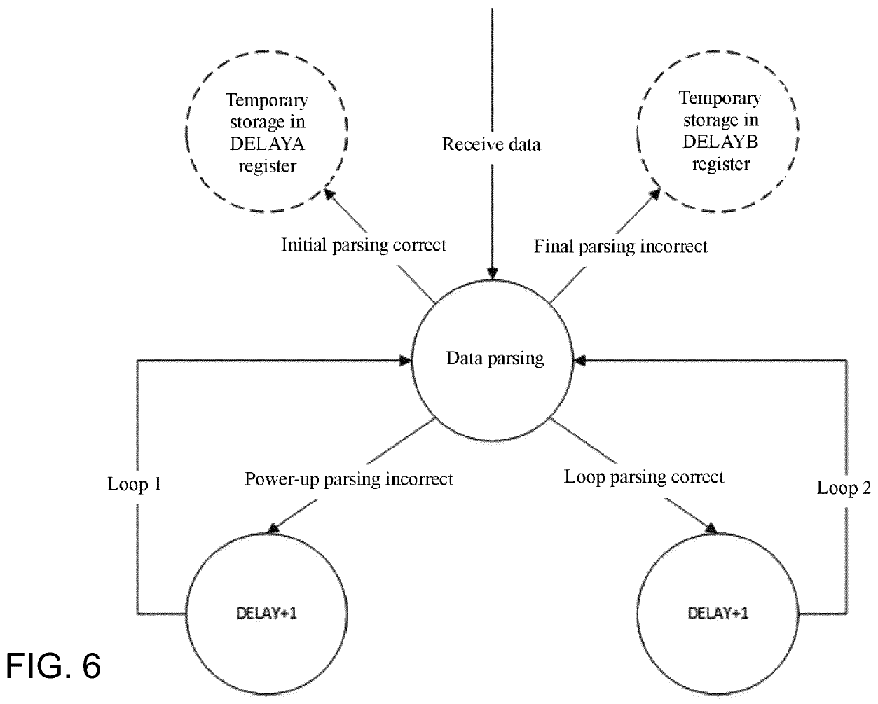

In a specific application embodiment, the adjustment step size is set to 1. As shown in FIG. 6, when the PING message cannot be parsed upon power-up, the steps for capturing the DELAY value corresponding to the optimum sampling point are as follows:
(1) incrementing DELAY by 1;
(2) parsing the PING message;
(3) if the initial parsing is correct, writing the current DELAY value (minimum DELAY value A) into the DELAYA register and executing S214, and if the parsing is incorrect, looping through S211 and S212;
(4) incrementing DELAY by 1;
(5) parsing the PING message;
(6) if parsing is correct, looping through S214 and S215, and if parsing is incorrect, decrementing the current DELAY value by 1 to obtain a DELAY value (maximum DELAY value B) and writing the same into the DELAYB register; and
(7) obtaining the DELAY value corresponding to the optimum sampling point (A+B)/2 (rounded off).

### Second Scenario: Able to Parse the PING Message Upon Power-Up

If the data parsing control module 3 is able to parse the PING message after power-up, capturing the DELAY value corresponding to an optimum sampling point based on the parsing results for each DELAY value comprises:
S221, obtaining a configuration value of the minimum DELAY value;
S222, increasing the current DELAY value based on the preset step size and evaluating the possibility of successfully parsing the PING message by the data parsing control module 3 at the current DELAY value, if parsing fails, decreasing the current DELAY value based on the preset step size until an initial parsing error occurs, and obtaining the maximum DELAY value based on the DELAY value corresponding to the initial parsing error; and
S223, calculating the DELAY value corresponding to the optimum sampling point based on the maximum DELAY value and the configuration value of the minimum DELAY value.

In S223, the DELAY value corresponding to the optimum sampling point is obtained using the formula (A+B)/2, A being the minimum DELAY value and B being the maximum DELAY value.

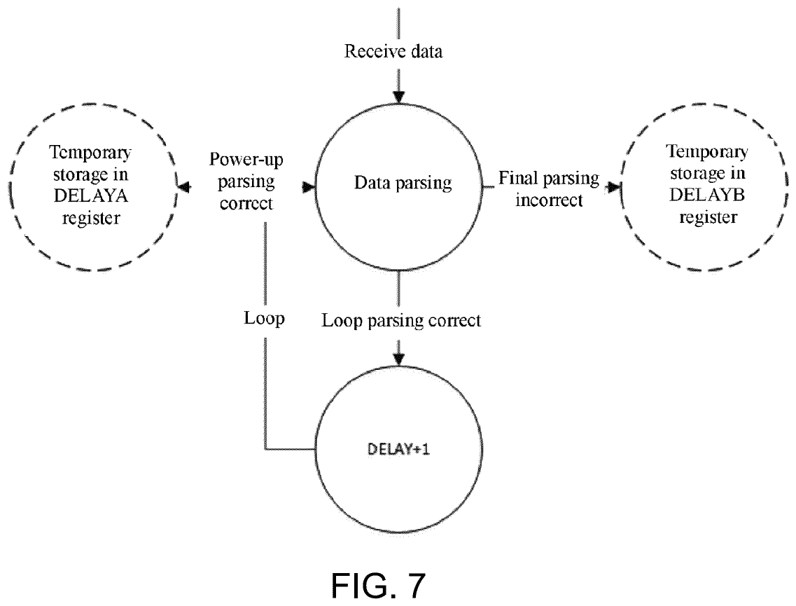

In a specific application embodiment, the adjustment step size of the DELAY value is set to 1. As shown in FIG. 7, when the PING message can be parsed upon power-up, the steps for capturing the DELAY value corresponding to the optimum sampling point are as follows:
(1) setting the minimum DELAY value A in the DELAYA register to 0;
(2) incrementing DELAY by 1;
(3) parsing the PING message;
(4) if parsing is correct, looping through (2) and (3), and if parsing is incorrect, decrementing the current DELAY value by 1 to obtain N (0<N<32) and writing the same into the DELAYB register; and
(5) obtaining the DELAY value corresponding to the optimum sampling point N/2 (rounded).

The minimum DELAY value A in (1) may also be set to other values based on actual requirements. When set to other values, the calculation formula for the DELAY value corresponding to the optimum sampling point needs to be adjusted to (A+N)/2.

This embodiment further provides a chip. The chip comprises a chip body, and the signal skew compensation apparatus as described above or a module for executing the above signal skew compensation method is arranged inside the chip body.

This embodiment also provides a computer-readable storage medium storing a computer program, and the computer program, when executed, realizes the above signal skew compensation method.

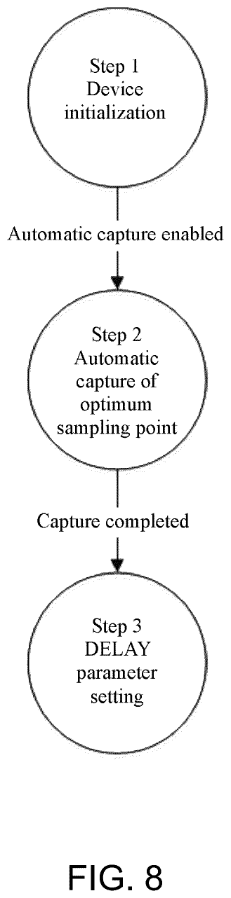

As shown in FIG. 8, this embodiment further provides a data communication method, comprising:
resetting a receiving device after power-up and performing initialization settings, the receiving device being equipped with the signal skew compensation apparatus as described above or a module for executing the above signal skew compensation method;
controlling synchronization between the receiving device and a transmitting device, the synchronization being accomplished by capturing the DELAY value corresponding to an optimum sampling point based on the above signal skew compensation method and setting the DELAY value based on the DELAY value corresponding to the optimum sampling point; and
after the synchronization is completed, beginning to receive, by the receiving device, a data stream sent by a transmitting end.

After the power-up initialization is completed at both the transmitting end and receiving end, synchronization operation must be conducted to ensure that the receiving end can properly parse the data, after which the transmitting end can begin transmitting the data stream. In this embodiment, the synchronization operation between devices is accomplished through PING messages (as shown in Table 1). Once automatic line delay adjustment is enabled, the skew compensation apparatus at the receiving end repeatedly parses the PING message until it obtains the optimum sampling relationship between the clock and the data, and then the DELAY value corresponding to the optimum sampling point is captured. Once the DELAY value is configured, the synchronization is completed, and the devices can begin data transmission and communication.

In a specific application embodiment, the skew compensation apparatus works in accordance with the sequence of power-up initialization, automatic capture of the optimum sampling point, and DELAY parameter setting during data communication. The detailed process is as follows:
power-up initialization: after power-up, resetting the transmitting device and the receiving device, configuring relevant registers, and initializing a link clock and a data signal to low;
automatic capture of the optimum sampling point: accomplishing the synchronization operation between devices through PING messages, that is, once automatic line delay adjustment is enabled, the receiving end repeatedly parses the PING message until it obtains the optimum sampling relationship between the clock and the data; and
DELAY parameter setting: based on the value (A) in the DELAYA register and the value (B) in the DELAYB register, setting the optimum sampling point value to ((A+B))/2 (rounded).

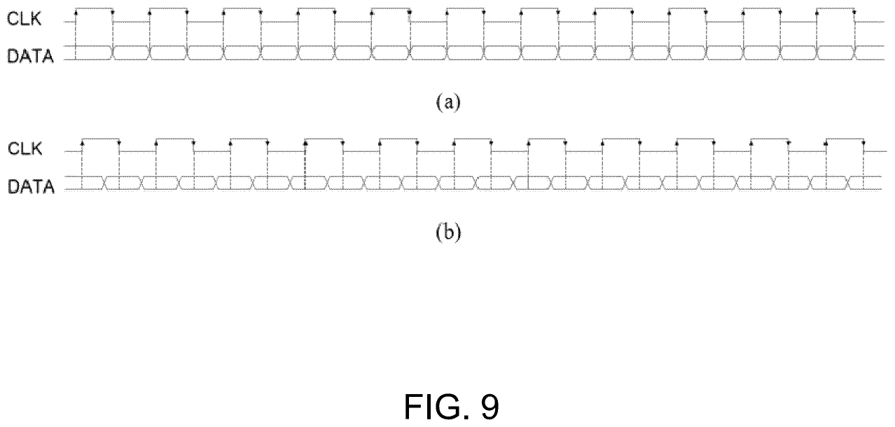

To verify the effectiveness of the invention, the following data signals are input: the maximum clock frequency is 150 MHz, the maximum double-edge data rate is 300 MHz, the data period is 3.33 ns, the period is divided into 32 TAPs, with a single TAP precision of 0.104 ns, and the DELAY line delay precision is set to 0.10 ns. Before adjustment using the aforementioned skew compensation apparatus, the ideal communication state is shown in (a) of FIG. 9. From the figure, it can be seen that during high or low temperature experiments, the clock sometimes samples data from the jitter region, leading to data errors. After automatic adjustment by the skew compensation circuit, the state is shown in (b) of FIG. 9. From the figure, it is evident that during high or low temperature experiments, there is strong compatibility with data jitter to the left or right, making the communication link more robust.

The invention, through skew compensation of data signals, not only mitigates the effects of line length mismatches and electronic components, but also enables more accurate and robust data acquisition by a clock, while also freeing up substantial CPU resources. Further, multiple line delay units are utilized to achieve adjustable line delay, covering 90% or even 100% of the signal range. This ensures that even in environments with poor signal quality, reliable and accurate data acquisition can still be achieved. Additionally, signal quality can be affected in both high and low temperature conditions. This invention can cover most of the signal range, thus enabling a more reliable acquisition of the signal stability zone and ensuring normal operation under high temperatures (during continuous work, resulting in chip temperature rise) or low temperatures (cold starts in cold highland areas).

As shown in the disclosure of the invention, unless explicitly indicated otherwise by the context, words such as “one”, “a”, “an”, and/or “the” do not necessarily refer to the singular and may also include the plural. Similarly, words such as “comprise” or “include” mean that the elements or objects appearing before the word cover the elements or objects listed after the word and their equivalents, without excluding other elements or objects. Words such as “connect” or “link” are not limited to physical or mechanical connection, but may include electrical connection, whether direct or indirect.

The aforementioned are merely preferred embodiments of the invention, and are not intended to limit the invention in any form. Although the invention has been disclosed in terms of preferred embodiments, it is not intended to limit the invention. Therefore, any simple modification, equivalent change and modification of the above embodiments based on the technical essence of the invention that do not depart from the content of the technical scheme of the invention shall fall within the protection scope of the technical scheme of the invention.

1. A signal skew compensation apparatus, characterized by comprising:
a clock detection module, configured to detect a frequency output of an input clock signal;
a DELAY module, configured to receive a data signal and introduce a delay, wherein a delay amount is controlled and delayed data is output based on the frequency detected by the clock detection module and a DELAY value output by a data parsing control module; and
the data parsing control module, configured to receive the delayed data and parse a PING message in the delayed data, and adjust the output DELAY value based on a parsing result,
the data parsing control module comprises a parsing circuit unit and a storage unit, and the parsing circuit unit is configured to parse the PING message in the delayed data, continuously adjust the DELAY value, and store a minimum DELAY value allowing successful parsing and a maximum DELAY value at which parsing begins to fail in the storage unit,
wherein the data parsing control module further comprises an optimum sampling point calculation unit configured to calculate the DELAY value corresponding to the optimum sampling point based on the minimum DELAY value and maximum DELAY value stored in the storage unit,
wherein if the data parsing control module fails to parse the PING message after power-up, a current DELAY value is increased based on a preset step size until the minimum DELAY value is obtained upon successful initial parsing, and the DELAY value is continuously increased until a parsing error occurs to obtain the maximum DELAY value,
wherein if the data parsing control module is able to parse the PING message after power-up, a configuration value of the minimum DELAY value is obtained, and the current DELAY value is increased based on the preset step size until the maximum DELAY value is reached upon an initial parsing error.

2. The signal skew compensation apparatus based on claim 1, wherein the DELAY module comprises a DELAY control unit and a DELAY unit which are interconnected, the DELAY control unit calculates a control value based on the frequency detected by the clock detection module and outputs the control value to the DELAY unit, and the DELAY unit generates a delay of a corresponding duration based on the control value and the DELAY value.

3. The signal skew compensation apparatus based on claim 2, wherein the DELAY unit comprises a line delay subunit and a selection subunit, the line delay subunit comprises a plurality of delay circuits which are sequentially connected, an output terminal of each of the delay circuits is connected to the selection subunit, and the selection subunit selects a target delay circuit for access based on the control value and the DELAY value, allowing the data signal to be output through the target delay circuit.

4. The signal skew compensation apparatus based on claim 3, wherein the control value is a jump value between the adjacent delay circuits in the desired delay circuits, and the selection subunit determines all the desired delay circuits from the line delay subunit based on the jump value, and selects the target delay circuit from the identified delay circuits based on the DELAY value.

5. The signal skew compensation apparatus based on claim 4, wherein the jump value is calculated as 300/Fre_det, wherein the Fre_det is the detected frequency value.

6. The signal skew compensation apparatus based on claim 4, wherein the selection subunit selects the delay circuit corresponding to the DELAY value from all the identified and desired delay circuits to serve as the target delay circuit.

7. The signal skew compensation apparatus based on claim 1, wherein the selection subunit is a multiplexer, and control terminals of the multiplexer respectively receive the control value and the DELAY value.

8. A signal skew compensation method, characterized by comprising:
detecting a frequency of an input clock signal;
receiving a data signal and introducing a delay, wherein a delay amount is controlled and delayed data is output based on the detected frequency and a DELAY value; and
receiving the delayed data and parsing a PING message in the delayed data, and adjusting the output DELAY value based on a parsing result,
wherein receiving the delayed data and parsing the PING message therein further comprises capturing the DELAY value corresponding to an optimum sampling point based on the parsing results for each DELAY value, comprising:
acquiring a minimum DELAY value allowing successful parsing and a maximum DELAY value at which parsing begins to fail;
calculating the DELAY value corresponding to the optimum sampling point based on the minimum DELAY value and the maximum DELAY value;
if a data parsing control module fails to parse the PING message after power-up, increasing a current DELAY value based on a preset step size until the minimum DELAY value is obtained upon successful initial parsing, and continuously increasing the DELAY value until a parsing error occurs to obtain the maximum DELAY value; and if the data parsing control module is able to parse the PING message after power-up, obtaining a configuration value of the minimum DELAY value, and increasing the current DELAY value based on the preset step size until the maximum DELAY value is reached upon an initial parsing error.

9. The signal skew compensation method based on claim 8, wherein controlling the delay amount based on the detected frequency and a DELAY value comprises:
calculating a control value based on the detected frequency; and
selecting a target delay circuit for access from a plurality of delay circuits which are sequentially connected based on the control value and the DELAY value, allowing the data signal to be output through the target delay circuit, and generating a delay of a corresponding duration.

10. The signal skew compensation method based on claim 9, wherein the control value is a jump value between the adjacent delay circuits in the desired delay circuits, all the desired delay circuits are identified from the plurality of delay circuits which are sequentially connected based on the jump value, and the target delay circuit is selected from the identified delay circuits based on the DELAY value.

11. The signal skew compensation method based on claim 10, wherein the jump value is calculated as 300/Fre_det, wherein the Fre_det is the detected frequency value, and a delay circuit corresponding to the DELAY value is selected from all the identified and desired delay circuits to serve as the target delay circuit.

12. The signal skew compensation method based on claim 8, wherein if the data parsing control module fails to parse the PING message after power-up, capturing the DELAY value corresponding to the optimum sampling point based on the parsing results for each of the DELAY value comprises:
increasing the current DELAY value based on the preset step size and evaluating a possibility of successfully parsing the PING message at the current DELAY value, if parsing fails, continuously increasing the DELAY value until initial successful parsing occurs, and obtaining the minimum DELAY value based on the DELAY value corresponding to the initial successful parsing;
continuously increasing the current DELAY value based on the preset step size and evaluating the possibility of successfully parsing the PING message at the current DELAY value, if parsing succeeds, continuing to increase the DELAY value until a parsing error occurs, and obtaining the maximum DELAY value based on the DELAY value corresponding to the parsing error; and
calculating the DELAY value corresponding to the optimum sampling point based on the minimum DELAY value and the maximum DELAY value.

13. The signal skew compensation method based on claim 12, wherein if the data parsing control module is able to parse the PING message after power-up, capturing the DELAY value corresponding to the optimum sampling point based on the parsing results for each DELAY value comprises:
obtaining a configuration value of the minimum DELAY value;
increasing the current DELAY value based on the preset step size and evaluating the possibility of successfully parsing the PING message at the current DELAY value, if parsing succeeds, decreasing the current DELAY value based on the preset step size until the initial parsing error occurs, and obtaining the maximum DELAY value based on the DELAY value corresponding to the initial parsing error; and
calculating the DELAY value corresponding to the optimum sampling point based on the maximum DELAY value and the configuration value of the minimum DELAY value.

14. The signal skew compensation method based on claim 12, wherein the DELAY value corresponding to the optimum sampling point is obtained using the formula (A+B)/2, wherein A is the minimum DELAY value and B is the maximum DELAY value.

15. A chip, comprising a chip body, wherein the signal skew compensation apparatus based on claim 1.

16. A computer-readable storage medium storing a computer program, wherein the computer program, when executed, realizes the method based on claim 8.

17. A data communication method, comprising:
resetting a receiving device after power-up and performing initialization settings, wherein the receiving device is equipped with the signal skew compensation apparatus based on claim 1;
controlling synchronization between the receiving device and a transmitting device, wherein the synchronization is accomplished by capturing the DELAY value corresponding to an optimum sampling point and setting the DELAY value based on the DELAY value corresponding to the optimum sampling point; and
after the synchronization is completed, beginning to receive, by the receiving device, a data stream sent by a transmitting end.

18. A chip, comprising a chip body, wherein the signal skew compensation apparatus a module for executing the method based on claim 8 is arranged inside the chip body.

19. A data communication method, comprising:
resetting a receiving device after power-up and performing initialization settings, wherein the receiving device is equipped with the signal skew compensation apparatus a module for executing the method based on claim 8;
controlling synchronization between the receiving device and a transmitting device, wherein the synchronization is accomplished by capturing the DELAY value corresponding to an optimum sampling point and setting the DELAY value based on the DELAY value corresponding to the optimum sampling point; and
after the synchronization is completed, beginning to receive, by the receiving device, a data stream sent by a transmitting end.
